(19) United States
(12) Patent Application Publication
(10) Pub. No.: US 2010/0072744 A1
(43) Pub. Date: Mar. 25, 2010

(54) Quick-Connect Structure for Quick Connection of Piping Elements

(76) Inventor: Qifu Xie, Beijing (CN)

Correspondence Address: WILLIAMS MULLEN, 222 CENTRAL PARK AVENUE, SUITE 1700, VIRGINIA BEACH, VA, 23462, US

(21) Appl. No.: 12/491,508

(22) Filed: Jun. 25, 2009

(30) Foreign Application Priority Data
Aug. 4, 2008 (CN) 200820122097.3

(51) Int. Cl. F16L 37/08

(52) U.S. Cl. 285/33

(57) ABSTRACT

The present invention provides a new-model quick-connect device for piping elements. It solves the problem of difficult disassembly, poor sealing and easy occurrence of leakage in quick-connect structures for piping elements. In one embodiment, the new-model quick-connect device for piping elements of the present invention comprises a main body having an interior surface defining a connecting hole, and the main body can connect with a connecting tube inserted into the connecting hole. An annular groove is provided in the inner surface of the main body defining the connecting hole, and a sealing washer that can form an air-tight or fluid-tight seal with the inserted connecting tube is embedded in the annular groove. Located radially outwardly of the sealing washer is a clamping ring that can connect with the connecting tube. The connecting ring has a plurality of jack catches that incline toward the inside of the connecting hole. When the tube or piping is inserted, the clamping ring grips the tubular member, providing increased opposing force to prevent disconnection. Radially outwardly of the clamping ring, there is an annular socket which can push away the jack catches when the clamping washer is pushed against the inner surface defining the connecting hole. The present invention is reliable to use, versatile and convenient, has a high sealing performance and can be used for temporary or permanent connections.

### REFERENCE TO RELATED APPLICATIONS

The present application is being filed under 35 USC 111(a) and claims the benefit pursuant to 35 USC 119(a) of Chinese patent application no. 200820122097.3, filed on Aug. 4, 2008, and entitled “New Pattern of Fast Connection Pipe Structure”, the disclosure of which is incorporated by reference in its entirety.

### TECHNOLOGICAL FIELD

The present invention relates to fluid flow, and more particularly relates to a new tubular quick-connect structure for piping elements.

### BACKGROUND ART

In daily life and industrial production equipment, there is often a need to connect and disassemble piping elements. In order to improve performance, others have designed all kinds of quick-connect structures, and some have applied for patents.

For example, Chinese patent documentation discloses a combined quick coupler which is applicable for various plastic pipe connections (Chinese Patent Application Number CN200420034737.7), comprising a joint that includes a pipe connection hole and seal groove, a sealing washer that is installed in the seal groove, a locking card that has at least 2 jack catches on the anterior inner wall with one end that extends into the seal groove, and an adjustment mounting that is joined to the external periphery of the coupler body and whose anterior inner wall tightly hugs the anterior external periphery of the locking card. In addition, a type of quick joint is disclosed in Chinese Patent Application Number CN200320107126.6, wherein a shoulder hole opens up at one end of the main body, the adapter sleeve connects with the main body through the flange at the front end of the main body, the endocone guide bushing connects with the main body through the adapter sleeve, an elastic sleeve with claw-like structures on its bottom end is installed inside the endocone guide bushing, a tapered pad is installed between the bottom of the endocone guide bushing and elastic sleeve and the main body, the tapered pad and the endocone guide bushing respectively have a sliding connection with the two inclined planes inside and outside the claw structure at the elastic sleeve, a sealing washer is placed between the tapered pad and the main body, a supporting sleeve is connected to the main body and is installed in the innermost part of the main body's shoulder hole, and, together with the elastic sleeve, tapered pad and sealing washer, a gap is formed for the connection hose.

The two methods above have the advantages of fast connection speed and reduction in time and effort, but there are still disadvantages. The difficulty in disassembling is extremely high, as well as the difficulty in separating the components after installation. Furthermore, the sealing is poor, and leakage occurs easily. In addition, the joint between the pipes and the coupler is not firm enough, and can be pulled out easily.

### DISCLOSURE OF THE INVENTION

Objects of the present invention include solving the aforesaid problems by providing a new-model quick connect structure for piping elements that is quick and convenient to install and disassemble, structurally sound, with good sealing effect, firm connection and ease of further processing.

In order to achieve the aforesaid objectives, the present invention adopts the following technical solution: A new-model quick-connect device for piping elements comprising a main body (1) having an interior surface defining a connecting hole (11) and an annular groove (12); a connecting tube (2) inserted into the connecting hole (11); sealing washers (5) embedded in the annular groove (12), wherein the sealing washers can form an air-tight seal with the inserted connecting tube (2); a clamping washer (3) positioned radially outside the sealing washer (5) and connected with the connecting tube (2), wherein the clamping washer (3) has a plurality of jack catches that incline towards the connecting hole (11); and an annular socket (4) provided radially outwardly of the clamping washer for pushing away the jack catches (3a) when the clamping washer is pushed against the main body interior surface defining the connecting hole (11).

Due to the fact that the jack catches incline towards the inside of the connection hole, when the connecting tube is inserted, the jack catches can fasten tightly on the external wall of the connecting tube and fix it in a firm position, thereby connecting the main body and the connecting tube. When the device needs to be disassembled, the annular socket can be pressed towards the inside of the connecting hole, and the annular socket will push away the jack catches and release the connecting tube, which allows the connecting tube to be conveniently extracted. The main body can be joined to the pipe through this structure. The main body can be a pipe, and can also be a device installed on a pipeline such as a water faucet or valve. When the device/structure needs to be disassembled, the external end of the annular socket can be pressed, or a special dismantling tool can be used. The structure of the dismantling tool can be designed to be annular, or take on a C-shape, with one end having a groove that can fasten to the external part of the annular socket. As the sealing washer is installed inside the integral annular groove, when the connecting tube is inserted, it is guided through the sealing washer by the integral tubing guide member, which prevents the sealing washer's movement, thereby effectively improving sealing performance.

In the aforesaid new-model quick connect device for piping elements, the clamping washer is installed in the connecting hole through a cylindrical casing fixed in the connecting hole, and the clamping washer is located between the sealing washer and the cylindrical casing. The cylindrical casing is used to restrict the clamping washer in the connecting hole to prevent it from being released and the connecting tube can enter the connection hole through the cylindrical casing. Of course, the clamping washer can also be installed in the connection hole through an annular groove that is set up in the connecting hole.

In the aforesaid new-model quick connect device for piping elements, the clamping washer can have an annular frame which has several jack catches uniformly distributed on it.

In the aforesaid new-model quick connect device for piping elements, a first convex shoulder and a second convex shoulder can be provided in the inner wall of the connecting hole, and the second convex shoulder can be located on the outside of the first convex shoulder, the inner top end of the cylindrical casing can be supported on the second convex shoulder, and a gap can be formed between the cylindrical casing and the first convex shoulder such that the annular frame of the clamping washer is located in the gap. As the clamping washer is installed in the gap, it can realize axial movement, and this structure is beneficial for connecting and dismantling, thereby improving working stability.

In the aforesaid new-model quick connect device for piping elements, the inner end of the annular socket has a cuniform head which can be used for pushing away the jack catches. The outside end of the annular socket extends to the outside of the connecting hole. When the annular socket presses against the inside of the connecting hole, the cuniform head will be able to conveniently push away the jack catches. As the outside end of the annular socket extends to the outside of the connecting hole, pressing can be conveniently realized manually or using a special tool.

In the aforesaid new-model quick connect device for piping elements, there is a fender outside the cuniform head. There are some annular steps on the inner wall of the cylindrical casing. The fender can lean upon the annular steps. This structure can prevent the annular socket and cylindrical casing from being released.

In the aforesaid new-model quick connect device for piping elements, the roof of the external part of the cylindrical casing is on the wrap edge of the opening at the connecting hole. This structure can conveniently fix the cylindrical casing in the connecting hole easily. The wrapping here can be formed by riveting.

In the aforesaid new-model quick connect device for piping elements, the clamping washer is formed through annular sheet steel stamping.

In the aforesaid new-model quick connect device for piping elements, silica gel is applied between the sealing washer and the connecting hole.

In the aforesaid new-model quick connect device for piping elements, the periphery of the main body has an annular platform, which is beneficial for installation, and for fixing the position when carrying out riveting at the wrapping.

Compared with the prior art, the new-model quick connect device for piping elements has the following advantages:
1. When the connecting tube is inserted into the connecting hole, the jack catches on the clamping washer will conveniently clamp the connecting tube, thereby realizing quick connection. Due to the fact that the jack catches incline towards the inside of the connecting hole, the connecting tube will not be released and the connection between them is very reliable. If the sealing ring is damaged during insertion of the pipe or tubing, the sealing washer may be removed using an o-ring picking tool, then replaced by sliding the new sealing washer into the sealing washer groove.
2. When pressing the annular socket, it can push away the jack catches to achieve quick separation, and usage is very nimble and convenient.
3. As the sealing washer is installed inside the annular groove, when the connecting tube is inserted, the sealing washer cannot move, thereby effectively improving sealing performance.
4. As the periphery of the main body has an annular platform, it is convenient to fix the position when riveting.

### DESCRIPTION OF THE DRAWINGS

FIG. 1 is a sectional-view of the structural schematic diagram of one embodiment of the device of the present invention.

FIG. 2 is a diagram of a special tool used for dismantling the device of the present invention.

In the diagrams, there are shown the main body 1, connecting hole 11, annular groove 12, first convex shoulder 13, second convex shoulder 14, gap 15, wrap edge 16, platform 17, connecting tube 2, clamping washer 3, jack catch 3a, annular frame 3b, annular socket 4, cuniform head 4a, fender 4b, sealing washer 5, cylindrical casing 6, annular step 6a, special tool 8, opening 8a, groove 8b.

### DESCRIPTION OF EMBODIMENTS OF THE INVENTION

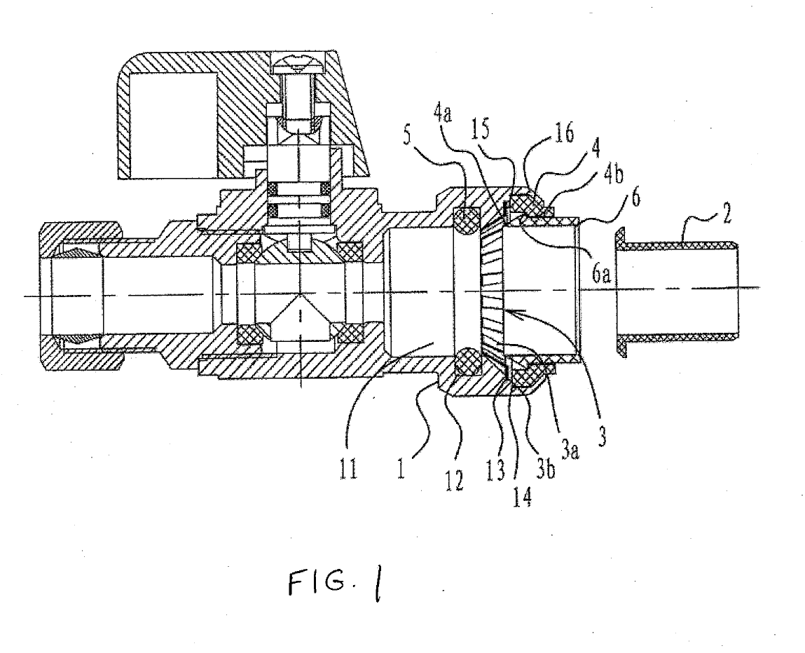

As shown in FIG. 1, the new-model quick-connect device for piping elements of the present invention comprises a main body (1) having an interior surface defining a connecting hole (11), a clamping washer (3) that is installed adjacent the interior surface and in the connecting hole (11), an O-shaped sealing washer (5) and an annular socket (4) fixed adjacent the interior surface and in the connecting hole (11). The main body (1) can connect with the connecting tube (2) inserted into the connecting hole (11). The main body can be a pipe, and can also be a device installed on a pipeline such as a water faucet or valve. The embodiment shown in FIG. 1 uses the valve body of a ball valve.

The clamping washer (3) has a plurality of jack catches (3a) that incline towards the inside of the connecting hole (11). The clamping washer (3) is made up of the annular frame (3b) and a plurality of jack catches (3a) uniformly distributed on the annular frame (3b). The clamping washer (3) can be formed through annular sheet steel stamping. Radially outwardly of the clamping washer (3), there is an annular socket (4) which can push away the jack catches (3a) when pressed towards the inside of the connecting hole (11). The inner end of annular socket (4) has a cuniform head (4a) which can be used for pushing away jack catches (3a). The radially outward end of the annular socket (4) defines the radially outermost portion of the connecting hole (11). There is a fender (4b) outside the cuniform head (4a). There are a plurality of annular steps (6a) on the inner wall of the cylindrical casing (6). The fender (4b) can lean upon the annular steps (6a).

In this embodiment, the clamping washer (3) is set up in the connecting hole (11) through a cylindrical casing (6) fixed against the annular socket in the connecting hole (11), and the clamping washer (3) is located between the sealing washer (5) and cylindrical casing (6). There is a first convex shoulder (13) and a second convex shoulder (14) in the inner wall of the main body that defines the connecting hole (11), and the second convex shoulder (14) is located radially outwardly of the first convex shoulder (13), and the inner top end of the cylindrical casing (6) is supported on the second convex shoulder (14), wherein the cylindrical casing (6) and the first convex shoulder (13) form a gap (15) therebetween, with the annular frame (3b) of the clamping washer (3) being located in the gap (15). The roof of the external part of the cylindrical casing (6) is on the wrap edge (13) of the opening at the connecting hole (11). The wrap edge (13) can be formed by riveting. As the clamping washer is installed in the gap, it can realize axial movement, and this structure is beneficial for connecting and dismantling, thereby improving working stability.

In order to improve sealing performance, an O-shape sealing washer (5) fixed in the connecting hole (11) is installed radially inwardly of the clamping washer (3). Silica gel is applied between the O-shape sealing washer (5) and the main body interior wall defining the connecting hole (11). In particular, the main body interior wall defining the connecting hole (11) has an annular groove (12) installed with the sealing washer (5) to form an air-tight seal with the inserted connecting tube (2), and the clamping washer (3) is located between the sealing washer (5) and the cylindrical casing (6). When the connecting tube (2) is inserted, the sealing washer (5) cannot move because the sealing washer (5) is installed in the annular groove (12), so that sealing performance is improved.

In order to facilitate the processing, the periphery of the main body (1) has an annular platform (17). When carrying out riveting on the wrap edge, fixing of position is facilitated through the platform (17).

When connecting, the connecting tube (2) is inserted into the connecting hole (11) at the main body (1). Due to the fact that the jack catches (3a) incline towards the inside of the connecting hole (11), the jack catches (3a) can fasten tightly onto the external wall of the connecting tube (2) to fix it when the connecting tube (2) is inserted, realizing the fast connection between the main body (1) and connecting tube (2).

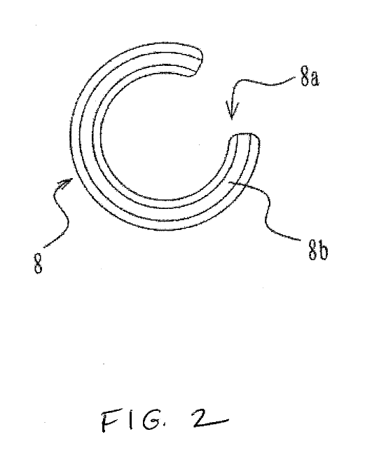

As shown in FIG. 2, special tool (8) has a C-shape, with an inner surface that defines \ an opening (8a), and with grooves (8b) along the lateral section. The opening (8a) enables the special tool (8) to be conveniently attached to the pipe. The grooves (8b) of the special tool (8) and the external end of the annular socket (4) are mutually joined together. When dismantling needs to be carried out, the annual socket (4) is pressed towards the inside of the connecting hole (11) by the special tool (8). The cuniform head (4a) at the anterior part of the annular socket (4) can push away the jack catches (4a) to release the connecting tube (2). This facilitates the extraction of the connecting tube (2) to achieve quick dismantling.

The specific embodiments described in this document are just examples demonstrating the spirit of this utility model. A technician skilled in the field of the utility model can modify or supplement the embodiment or adopt similar substitutes, but shall not deviate from the spirit of this utility model or exceed the scope as set out in the claims.

Although this document refers largely to the technical terms such as main body 1, connecting hole 11, annular groove 12, first convex shoulder 13, second convex shoulder 14, gap 15, wrap edge 16, platform 17, connecting tube 2, clamping washer 3, jack catch 3a, annular frame 3b, annular socket 4, cuniform head 4a, fender 4b, sealing washer 5, cylindrical casing 6, annular step 6a, special tool 8, opening 8a, groove 8b, it does not exclude the possibility of using other technical terms. The technical terms are merely for the convenience of describing and explaining the essence of the utility model. Interpreting the technical terms to impose any further limitations would go against the spirit of this utility model.

1. A new-model quick-connect device for piping elements, comprising:
a main body (1) having an interior surface defining a connecting hole (11) and an annular groove (12),
a connecting tube (2) inserted into the connecting hole (11);
a sealing washer (5) embedded in the annular groove (12), wherein the sealing washer can form an air-tight seal with the inserted connecting tube (2);
a clamping washer (3) positioned radially outwardly of the sealing washer (5) and connected with the connecting tube (2), wherein the clamping washer (3) has a plurality of jack catches that incline towards the connecting hole (11); and
an annular socket (4) provided radially outwardly of the clamping washer for pushing away the jack catches (3a) when the clamping washer is pushed against the surface defining the connecting hole (11).

2. The device according to claim 1, wherein a cylindrical casing (6) is fixed against the annular socket in the connecting hole (11), and the clamping washer (3) is located in an integral groove between the sealing washer and the cylindrical casing (6).

3. The device according to claim 1, wherein the clamping washer (3) has an integral annular frame (3b) which has a plurality of jack catches (3a) uniformly distributed thereon.

4. The device according to claim 3, further including a first convex shoulder (13) and a second convex shoulder (14) in the inner wall of the main body that defines the connecting hole (11), with the second convex shoulder (14) located radially outwardly of the first convex shoulder (13), the inner top end of the cylindrical casing (6) is supported on the second convex shoulder (14), wherein the cylindrical casing (6) and the first convex shoulder (13) form a gap (15) therebetween, with the annular frame (3b) of the clamping washer (3) being located in the gap (15)

5. The device according to claim 1, wherein the radially inner end of the annular socket (4) has a cuniform head (4a) for pushing away jack catches (3a) and wherein the radially outer end of the annular socket (4) defines the radially outermost portion of the connecting hole (11).

6. The device according to claim 5, wherein a fender (4b) is positioned outside the cuniform head (4a), annular steps (6a) are provided on the inner wall of the cylindrical casing (6) and wherein the fender (4b) leans upon the annular steps (6a).

7. The device according to claim 4, wherein the cylindrical casing (6) includes an external roof on a wrap edge (16) of the opening at the connecting hole (11).

8. The device according to claim 5, wherein the clamping washer (3) is formed through annular sheet steel stamping.

9. The device according to claim 5, wherein silica gel is applied between the sealing washer (5) and the connecting hole (11).

10. The device according to claim 5, wherein the main body (1) includes a periphery having an annular platform (17).
